(19) United States
(12) Patent Application Publication
(10) Pub. No.: US 2008/0160165 A1
(43) Pub. Date: Jul. 3, 2008

(54) Food Products Comprising Starch Phosphorylated With Sodium Trimetaphosphate That Retain Dietary Fiber And Methods Of Making Said Food Products

(76) Inventor: Dorothy J. Peterson, St. John, IN (US)

Correspondence Address: CARGILL, INCORPORATED, LAW DEPARTMENT, P. O. BOX 5624, MINNEAPOLIS, MN, 55440-5624, US

(21) Appl. No.: 11/660,127

(22) PCT Filed: Aug. 12, 2005
(86) PCT No.: PCT/US05/28632

§ 371 Date: Feb. 15, 2008

Related U.S. Application Data
(60) Provisional application No. 60/600,796, filed on Aug. 12, 2004.
(60) Provisional application No. 60/699,662, filed on Jul. 15, 2005.

(51) Int. Cl. A23L 1/0522

(52) U.S. Cl. 426/661

(57) ABSTRACT

The present invention provides products comprising a starch phosphorylated with sodium trimetaphosphate (STMP), methods of making such products, and methods of reducing loss of fiber content in food products employing such phosphorylated starch.

### RELATED APPLICATIONS

The present application claims priority to U.S. Provisional Patent Application No. 60/600,796, filed Aug. 12, 2004, and U.S. Provisional Patent Application No. 60/699,662, filed Jul. 15, 2005, each of which is hereby incorporated by reference in its entirety.

### INTRODUCTION

The present invention provides dietary fiber containing products, methods of making such products, and methods of reducing loss of fiber content in food products.

“Dietary fiber,” or simply “fiber,” are the terms used to describe the fibrous or gummy portions of food that are resistant to digestion in the body. Recent studies have shown that diets high in dietary fiber have beneficial effects on health. For example, studies have suggested that diets rich in dietary fiber can reduce the risk of cardiovascular disease, cancer, gastrointestinal problems, and obesity. See Campos et al., NUTR HOSP. 20(1):18-25 (2005) (suggesting a link between the occurrence of colorectal cancer and low fiber diet); Kendall et al., CURR, ATHEROSCLER REP. 6(6):492-8 (2004) (suggesting that a diet rich in fiber can reduce LDL cholesterol); Kendall et al., J. AOAC INT. 87(3):769-74 (2004) (suggesting that a diet high in fiber can reduce the risk of chronic disease); Cernea et al., ACTA DIABETOL. 40 Suppl 2:S389-400 (2003) (suggesting that a diet high in fiber can reduce the risk of cardiovascular disease).

Nutritionists generally recommend 20 to 35 grams of fiber per day or 10 to 13 grams of fiber per 1,000 kilocalories. Nonetheless, the average daily intake of fiber in the United States is only around 10 to 15 grams per day. Thus, a large proportion of the American population fails to meet the recommended daily intake of fiber.

Given the benefits of fiber and the fiber deficiency common in diets, a number of attempts have been made to increase the fiber content of food. Some of these attempts have focused on simply adding fiber to food products. Such attempts have been met with limited success because the addition of fiber to food frequently alters the food's taste and texture. For example, certain types of fiber absorb moisture from food, causing a toughening effect.

Other attempts to increase fiber content in food have involved the use of resistant starches. Unlike traditional fiber sources, resistant starches do not significantly affect the flavor or texture of foods. While not technically fiber, resistant starches share the functional attributes of fiber, thereby allowing them to be measured as dietary fiber for labeling purposes. Like fiber, resistant starches resist digestion in the small intestine—meaning, to varying degrees, they can pass through the small intestine virtually intact. Because the human body does not digest resistant starches, it does not absorb the starches' calories and glucose. Consequently, foods containing high levels of resistant starch may yield fewer calories and lower glycemic loads. Such foods would be important formulation considerations for diabetics as well as the weight-conscious.

Resistant starches are usually classified into four categories: RS₁, RS₂, RS₃ and RS₄. RS₁ are physically inaccessible starches, entrapped within a cellular matrix, as found in partially milled grains, seeds and legumes. RS₂ are naturally resistant, granular starches, as found in raw potatoes and bananas. RS₃ are retrograded or crystalline, non-granular starches, as found in processed foods. RS₄ are chemically modified or re-polymerized starches, such as cross-linked dextrins. While RS₁, RS₂, and RS₃ become vulnerable to α-amylase digestion upon solubilization in a concentrated base, such as sodium hydroxide or dimethyl sulfoxide, RS₄ remains resistant to α-amylase digestion even when dissolved in said base.

For some resistant starches, their ability to resist digestion depends upon maintaining a granular structure. However, a number of food products are made under conditions that disrupt the granular integrity of resistant starches, thereby limiting their capacity to increase the products' fiber content. Examples of such products include cereals, chips, pretzels, flakes and various other snacks made by extrusion processes utilizing high heat, pressure and shear parameters. These products are broad in scope and appeal to a large number of consumers. Accordingly, methods of enhancing the fiber content of these products without significantly altering their taste or texture, is extremely desirable.

### SUMMARY OF THE INVENTION

One aspect of the present invention provides a food product comprising: (i) one or more food ingredient(s); and (ii) a starch phosphorylated with STMP, said food product having been extruded.

Another aspect of the present invention provides a method of preparing an extruded food product, which comprises: (i) combining one or more food ingredient(s) with a starch phosphorylated with STMP to yield a combination; and (ii) extruding the combination of step (i).

Yet another aspect of the present invention provides a method of reducing loss of fiber content in an extruded food product, which comprises: (i) combining one or more food ingredient(s) with a starch phosphorylated with STMP to yield a combination; and (ii) extruding the combination of step (i).

These and other embodiments are more fully described in the following detailed description of the invention.

### DETAILED DESCRIPTION

Extrusion processes are known to degrade dietary fiber because of the harsh manufacturing conditions employed, such as high heat, pressure and shear parameters. The present invention is based on the surprising discovery that some extruded food products made with certain phosphorylated starches have a higher percentage of dietary fiber as compared to control products made without such phosphorylated starches and/or with other phosphorylated starches. Hence, these phosphorylated starches may be used in methods for preparing extruded food products and in methods for reducing loss of fiber content in extruded food products.

The products and methods of the present invention are described in greater detail below.

Unless otherwise indicated, “a” or “an” refers to one or more than one.

Unless otherwise specified, “dietary fiber” and “fiber” are used as equivalent terms and include anything classified as fiber according to Association of Official Analytical Chemists (AOAC) Method 991.43. The fiber content of a given food product may be measured by any test known in the art. However, for the purposes of determining whether a method or product falls within the scope of the present invention, fiber content is measured by AOAC Method 991.43.

a. Starches

In some embodiments, the starch used to practice the present invention is phosphorylated. For example, the starch can be phosphorylated with one or more agent(s) selected from sodium trimetaphosphate (STMP) and sodium tripolyphosphate (STPP). In some embodiments, the starch is phosphorylated with STMP or a mixture of STMP and STPP.

In some embodiments, the starch is phosphorylated with sodium trimetaphosphate (STMP) and sodium tripolyphosphate (STPP), using any method known in the art. For example, the starch may be phosphorylated according to a method described in U.S. Pat. Nos. 5,855,946 or 6,299,907, the entire contents of which patents are incorporated herein by reference. In further embodiments, the starch is phosphorylated in the presence of sodium chloride in an aqueous slurry reaction at basic pH with moderate heating. In yet further embodiments, the starch is phosphorylated with about 1-20% by weight STMP, either alone or in combination with STPP, based upon the weight of the unmodified starch taken as 100% by weight. In yet further embodiments, the starch is phosphorylated with STMP and STPP at a weight-to-weight STMP:STPP ratio greater than 90:10, greater than 95:5, greater than 99:1, or greater than 99.9:1.

The starch may be derived from any source known in the art, including wild-type and mutant hybrid plants. Non-limiting sources of starch include common corn, tapioca, wheat, potato, rice, sweet potato, arrowroot, sago, pea (smooth or wrinkled), barley, banana, manioc, oat, mung bean, and corn. The starch may be modified to alter its natural composition or structure. The alteration can be a result of genetic engineering, controlled plant breeding, or chemical modification. In addition, starches from different sources may be combined. For example, a blend of tapioca and corn starch can be used. One of ordinary skill in the art can readily alter starches or blend starches to achieve a desired composition depending on the particular application.

In some embodiments, the starch comprises at least about 30%, at least about 50%, at least about 60%, at least about 70%, at least about 75%, at least about 80%, at least about 85%, at least about 90%, or at least about 95% amylose, by weight of the starch. In further embodiments, the starch is a high-amylose starch. Non-limiting examples of high-amylose starches are described in Richardson et al., MRS BULLETIN December 2000, pp. 20-24, the entire contents of which is incorporated herein by reference. High-amylose corn starches can be produced by manipulating a single recessive gene, the amylose-extender (ae) gene. Amylose-extender dull, amylose-extender sugary-2, and dull sugary-2 are varieties of corn that produce high-amylose starches.

In some embodiments, the starch is a phosphorylated starch comprising at least about 50% by weight amylose. In further embodiments, the starch comprises at least about 70% by weight amylose. In yet further embodiments, the starch is a phosphorylated high-amylose starch derived from corn. Non-limiting examples of a high-amylose corn starch include Class V (at least about 50% by weight amylose), Class VII (at least about 70% by weight amylose) and Class IX (at least about 90% by weight amylose) starches. In yet further embodiments, the starch is phosphorylated with STMP or a mixture of STMP and STPP.

In some embodiments, the starch is a phosphorylated starch derived from tapioca. In further embodiments, the tapioca-derived phosphorylated starch comprises about 10-25%, about 15-25% or about 15-20% by weight amylose. In yet further embodiments, the starch is phosphorylated with STMP or a mixture of STMP and STPP.

In some embodiments, the starch is a phosphorylated RS₃ or RS₄ starch. In further embodiments, the starch is a phosphorylated RS₃ starch. In yet further embodiments, the starch is a phosphorylated RS₄ starch.

b. Food Products And Methods Of Making The Same

One aspect of the present invention relates to an extruded food product comprising:
(i) one or more food ingredient(s); and
(ii) a phosphorylated starch, as described above.

Another aspect of the present invention relates to a method of preparing an extruded food product comprising:
(i) combining a phosphorylated starch, as described above, with one or more food ingredient(s) to yield a combination; and
(ii) extruding the combination of step (i).

In further embodiments, the phosphorylated starch is present in an amount of at least about 5%, at least about 10%, at least about 20%, at least about 30%, or at least about 50%, by weight.

In some embodiments, the extruded food product possesses enhanced dietary fiber content and, optionally, improved rigidity and/or crispiness due to reduced water content, relative to a control food product. In further embodiments, the phosphorylated starch retains at least about 20%, at least about 30%, at least about 40%, or at least about 50% dietary fiber after the extruding step. In yet further embodiments, the extruded food product comprises less than about 5% by weight, less than about 3%, less than about 2%, or less than about 1% by weight water.

The one or more food ingredient(s) may include any cooked or uncooked ingredients suitable for extrusion. Such ingredients are generally well-known in the art and can be readily selected by an ordinarily skilled artisan. In some embodiments, the one or more food ingredient(s) are selected from grain based products, such as corn, oat, wheat, rice, soy, barley, rye and triticale, in any available form, e.g. meal, flour, bran.

Any suitable extrusion process or extruding step may be used to practice the present invention. In some embodiments, the extrusion process or extruding step is carried out under harsh conditions, such as under extreme temperature, shear and/or pressure. For example, the extruding step may be carried out at a temperature of about 100° C. or more and/or pressure of about 600 p.s.i. or more.

In some embodiments, the extruded food product is selected from cereals, crackers, pretzels, and puffed, flaked and sheeted snacks. Other examples of an extruded food product would be readily apparent to one of ordinary skill in the art. In further embodiments, the extruded food product is rigid and/or crispy, such as in the form of curls, chips or crackers.

In some embodiments, the extruded food product comprises one or more additional starch(es) as described above. The additional starch(es) may be added to modify the taste or texture of the extruded food product.

The extruded food product may undergo further processing. For example, the extruded food product may be dried, baked, fried, cooled, puffed, flaked, and/or sheeted. These and other types of processing are well-known in the art.

c. Methods of Reducing Loss of Fiber

Another aspect of the present invention is a method of reducing loss of fiber content in an extruded food product, which comprises:
(i) combining a phosphorylated starch, as described above, with one or more food ingredient(s) to yield a combination; and
(ii) extruding the combination of step (i).

It will be apparent to one of ordinary skill in the art that specific embodiments of the present invention may be directed to one, some or all of the above-indicated aspects as well as other aspects, and may encompass one, some or all of the above- and below-indicated embodiments, as well as other embodiments. Thus, the various embodiments of phosphorylated starch, extruded food product and extruding step, as described above in sections (a) and (b), would also apply to the methods of reducing loss of fiber.

Unless otherwise indicated, all numbers expressing quantities of ingredients, reaction conditions, and so forth used in the specification and claim are to be understood as being modified by the term “about”. Such numbers are approximations that may vary depending upon the-desired properties sought to be obtained by the present invention. The term “about” includes those values that are within typical experimental error for the measurement. At the very least, and not as an attempt to limit the application of the doctrine of equivalents to the scope of the claims, each numerical parameter should be construed in light of the number of significant digits and ordinary rounding techniques.

While the numerical ranges and parameters setting forth the broad scope of the invention are approximations, the numerical values set forth in the working examples are reported as precisely as possible. Any numerical value, however, inherently contains certain errors necessarily resulting from the standard deviation found in their respective testing measurements.

### EXAMPLES

The following examples are illustrative of the present invention and are not intended to be limitations thereon.

### Example 1

### Manufacture of Corn Curls

Corn curls were made using the starches described herein.

A. Batches Tested

Five different types of starch were used to manufacture the corn curls. Specifically, the five different types of starch were incorporated into the final corn curl product at 30% by weight, and in some cases 50% by weight, as shown below in Table 1.

TABLE 1
Starches Tested

| | Inclusion levels in | |
|---|---|---|
| Starches Tested | finished product | |
| Product A - Fibersym HA ™ (available | 30% | 50% |
| from Cargill, Inc.; STMP/STPP cross- | | |
| linked 70% amylose corn starch) | | |
| Product B - Actistar RT ™ (available from | 30% | 50% |
| Cargill Inc.; STMP/STPP cross-linked 15-25% | | |
| amylose tapioca starch) | | |
| Product C - STMP/STPP cross-linked | 30% | |
| 50% amylose corn starch | | |
| Product D - Amylogel 03003 (available | 30% | 50% |
| from Cargill, Inc.; unmodified 70% | | |
| amylose corn starch) | | |
| Product E - Hi-Maize ™ 260 (available | 30% | |
| from National Starch and Chemical | | |
| Company; unmodified 70% amylose corn | | |
| starch) | | |

The corn curls were made in fifty pound batches. The batches included a control batch, which contained no starch product, a 30% starch product inclusion batch, and a 50% starch inclusion batch. The batches made are illustrated below in Table 2.

TABLE 2
Corn Curl Batches

| | Control | | 30% Inclusion | | 50% Inclusion | |
|---|---|---|---|---|---|---|
| | % | Pounds | % | Pounds | % | Pounds |
| Corn | 100 | 50 | 70 | 35 | 50 | 25 |
| Meal | | | | | | |
| Starch | | | 30 | 15 | 50 | 25 |
| Test | | | | | | |
| Product | | | | | | |
| Total | 100 | 50 | 100 | 50 | 100 | 50 |

The batches were made by weighing out the ingredients in the amounts shown in Table 2 using a balance manufactured by A&D Company, Ltd. (model #FV-60KWP) and blending the ingredients for 3 to 4 minutes in a Wenger ribbon mixer (model Premixer 2.5×3). In all, there were 9 batches made: 8 test batches (5 at 30% starch inclusion and 3 at 50% starch inclusion) and 1 test batch.

B. Extrusion

After blending, the control batch was placed in the hopper of a Wenger Model TX-57 extruder. From there, the control batch entered a preconditioning cylinder, which blends the dry matter at 120 rpm and 68° F. From the preconditioning cylinder, the matter entered the extruder and water was added at a rate of 0.103 kg/min. The total time for the product to enter the hopper and exit the extruder was 25 seconds, and it took about 15-20 minutes for the batch to run through the extruder. Table 3 lists the processing conditions at which the extruder was run:

TABLE 3
Extruder Conditions

| | |
|---|---|
| Extruder Shaft Speed | 300 +/− 2 rpm |
| Extruder Motor Load | 60 +/− 5% |
| Water Flow to the extruder | 0.103 kg/min |
| Knife Drive Speed | 20% |
| Actual Temperature 1st head | 32° C. |
| Actual Temperature 2nd head | 80° C. |
| Actual Temperature 3rd head | 110° C. |
| Die Spacer Temperature | 136 +/− 4° C. |
| Head #2 Pressure | 800 +/− 100 psi |
| Die Pressure | 850 +/− 50 psi |

The extruded product was then cut and sent to a continuous dryer (Wenger, model 4800) where it took 8-9 minutes for the product to dry at 105° C. The corn curls were then moved to a long conveyer for cooling and packaged. This process was repeated for each of the 10 batches.

C. Results

All corn curls were analyzed for total dietary fiber and moisture content. Total dietary fiber was calculated using The Association of Analytical Communities, International (AOAC) method 991.43, which is hereby incorporated by reference, and the moisture content was determined by forced air oven. Table 4 below shows the final fiber and moisture content for each sample analyzed:

TABLE 4
Total Dietary Fiber of Final Product and Moisture
Content of Corn Curls

| | Total Dietary | |
|---|---|---|
| Product | Fiber (%) | Moisture (%) |
| Control | 2.9 | 2.96 |
| 30% Inclusion | | |
| Product A | 18.6 | 2.28 |
| Product B | 17.8 | 2.24 |
| Product C | 12.0 | 2.03 |
| Product D | 6.6 | 2.20 |
| Product E | 5.0 | 2.76 |
| 50% Inclusion | | |
| Product A | 18.9 | 2.00 |
| Product B | 18.8 | 1.84 |
| Product D | 13.8 | 2.32 |

These results indicate that the phosphorylated starches allow a higher content of dietary fiber as compared to non-phosphorylated starches.

Based on these results, the recovery rate of the fiber provided by each starch tested was calculated. The recovery rate refers to:

$$\frac{DietaryFiberContentOfStarchProductAfterExtrusion}{DietaryFiberContentOfStarchProductBeforeExtrusion} * 100$$

The results are shown below in Table 5.

TABLE 5
Corn Curl Fiber Retention

| Product | Recovery Rate |
|---|---|
| 30% Inclusion | |
| Product A | 67.97% |
| Product B | 59.13% |
| Product C | 39.16% |
| Product D | 53.47% |
| Product E | 11.93% |
| 50% Inclusion | |
| Product A | 41.56% |
| Product B | 37.86% |
| Product D | 94.50%* |

*The value of this data point is questionable.

### Example 2

### Manufacture of Oat Cereal

Oat cereal was manufactured as a further example of the advantages achieved using the present invention. Oat cereal is made under high temperature, shear, and pressure condition, although not as extreme as corn curl manufacturing conditions.

A. Batches Tested

The same starch products at the same inclusion levels as in Example 1 were used to make the oat cereal. However, the oat cereal batches had several additional ingredients, as shown below in Table 6.

TABLE 6
Oat Cereal Batches

| | Control | | 30% Inclusion | | 50% Inclusion | |
|---|---|---|---|---|---|---|
| | % | Pounds | % | Pounds | % | Pounds |
| Oat Flour | 62.5 | 31.25 | 43.75 | 21.875 | 31.25 | 15.625 |
| Starch Test | | | 30 | 15 | 50 | 25 |
| Product (See | | | | | | |
| Table 1) | | | | | | |
| StabiTex 06330 - | 30 | 15 | 21 | 10.5 | 15 | 7.5 |
| Sugar | 6 | 3 | 4.2 | 2.1 | 3 | 1.5 |
| Salt | 1 | 0.5 | 0.7 | 0.35 | 0.5 | 0.25 |
| Sodium | 0.5 | 0.25 | 0.35 | 0.175 | 0.25 | 0.125 |
| Bicarbonate | | | | | | |
| Total | 100 | 50 | 100 | 50 | 100 | 50 |

The batches were made in the same manner using the same equipment as described in Example 3.

B. Extrusion

Extrusion of the oat cereal was performed in a similar manner as in Example 3. Specifically, the control batch was placed in the hopper of a Wenger Model TX-57 extruder after mixing. From there, the control batch entered a preconditioning cylinder, which blended the dry matter at 120 rpm and 68° F. From the preconditioning cylinder, the matter entered the extruder where water was added at a rate of 0.150 kg/min and the product was cooked. The total time for the product to enter the hopper and exit the extruder was 15 seconds, and it took about 15-20 minutes for the batch to run through the extruder. Table 7 lists the processing conditions at which the extruder was run:

TABLE 7
Oat Cereal Extruder Conditions

| | |
|---|---|
| Extruder Shaft Speed | 300 +/− 2 rpm |
| Extruder Motor Load | 50 +/− 3% |
| Water Flow to the extruder | 0.150 kg/min |
| Knife Drive Speed | 75% |
| Actual Temperature 1st head | 30° C. |
| Actual Temperature 2nd head | 80° C. |
| Actual Temperature 3rd head | 110° C. |
| Die Spacer Temperature | 128 +/− 2° C. |
| Head #2 Pressure | 600 +/− 100 psi |
| Die Pressure | 700 +/− 100 psi |

The extruded product was then sent to a continuous dryer (Wenger, model 4800) where it was dried at 110° C. for 3 minutes in the top conveyer of the dryer and 4.1 minutes on the bottom conveyer of the oven. The oat cereal was then cooled and packaged. This process was repeated for each of the 9 batches.

C. Results

The final oat cereal product was analyzed as in Example 3. Table 8 lists the results of the analysis.

TABLE 8
Total Dietary Fiber and Moisture Content of Oat Cereal

| Product | TDF (%) | Moisture (%) |
|---|---|---|
| Oat Control | 10.4 | 1.84 |
| 30% Inclusion | | |
| Product A | 23.4 | 1.16 |
| Product B | 23.2 | 1.32 |
| Product C | 21.7 | 1.44 |
| Product D | 12.9 | 1.52 |
| Product E | 11.0 | 1.48 |
| 50% Inclusion | | |
| Product A | 30.9 | 1.52 |
| Product B | 33.2 | 1.40 |
| Product D | 15.5 | 1.48 |

Based on these results, recovery rate of the fiber provided by each starch tested was calculated. The results are shown below in Table 9.

TABLE 9
Oat Cereal Fiber Retention

| Product | Recovery Rate |
|---|---|
| 30% Inclusion | |
| Product A | 58.00% |
| Product B | 50.79% |
| Product C | 48.62% |
| Product D | 36.13% |
| Product E | 3.40% |
| 50% Inclusion | |
| Product A | 53.25% |
| Product B | 54.29% |
| Product D | 44.19 |

The invention being thus described, it will be apparent to those skilled in the art that the same may be varied in many ways without departing from the spirit and scope of the invention. Such variations are included within the scope of the invention to be claimed.

1. A food product comprising:
(i) one or more food ingredient(s); and
(ii) a starch phosphorylated with STMP, said food product having been extruded.

2. The food product of claim 1 wherein the starch is phosphorylated with a mixture of STMP and STPP.

3. The extruded food product of claim 1, wherein the starch comprises at least about 50% by weight amylose.

4. The extruded food product of claim 1, wherein the starch comprises at least about 70% by weight amylose.

5. The extruded food product of claim 1, wherein the starch is derived from tapioca.

6. The extruded food product of claim 1, wherein the starch is an RS₄ starch.

7. The extruded food product of claim 1, wherein the starch is a corn starch.

8. A method of preparing an extruded food product, which comprises:
(i) combining one or more food ingredient(s) with a starch phosphorylated with STMP to yield a combination; and
(ii) extruding the combination of step (i).

9. The method of claim 8, wherein the starch is phosphorylated with a mixture of STMP and STPP.

10. The method of claim 8, wherein the starch comprises at least about 50% by weight amylose.

11. The method of claim 8, wherein the starch comprises at least about 70% by weight amylose.

12. The method of claim 8, wherein the starch is derived from tapioca.

13. The method of claim 8, wherein the starch is an RS₃ or RS₄ starch.

14. The method of claim 8, wherein the starch is a corn starch.

15. A method of reducing loss of fiber content in an extruded food product, which comprises:
(i) combining one or more food ingredient(s) with a starch phosphorylated with STMP to yield a combination; and
(ii) extruding the combination of step (i).

16. The method of claim 15, wherein the starch is phosphorylated with a mixture of STMP and STPP.

17. The method of claim 15, wherein the starch comprises at least about 50% by weight amylose.

18. The method of claim 15, wherein the starch comprises at least about 70% by weight amylose.

19. The method of claim 15, wherein the starch is derived from tapioca.

20. The method of claim 15, wherein the starch is an RS₃ or RS₄ starch.

21. The method of claim 15, wherein the starch is a corn starch.
